(19) United States
(12) Patent Application Publication
(10) Pub. No.: US 2013/0089315 A1
(43) Pub. Date: Apr. 11, 2013

(54) FILTER MODULE AND PHOTOGRAPHING APPARATUS

(71) Applicant: Chih-Yi YANG, Taipei City (TW)

(72) Inventor: Chih-Yi YANG, Taipei City (TW)

(73) Assignee: Lumos Technology Co., Ltd.

(21) Appl. No.: 13/253,965

(22) Filed: Oct. 6, 2011

(51) Int. Cl. G03B 11/00; G02B 7/00

(52) U.S. Cl. 396/544; 359/892

(57) ABSTRACT

A filter module for connecting to a lens barrel of an image capturing module is disclosed. The filter module includes a filter, a frame and magnetic unit. The filter is for passing through a light beam with a specific wavelength. The frame is arranged around the filter. The magnetic unit is arranged on the frame for magnetic connecting the frame to the lens barrel. In addition, the present invention also disclosed a photographing apparatus having the above-mentioned filter module.

### BACKGROUND OF THE INVENTION

1. Field of the Invention

The present invention relates to a filter module, in particularly to a filter module for connecting to an image capturing module.

2. Description of Related Art

Digital camera has advantages of being capable of reviewing image immediately after the image is shot and digitally storing the shot images to electronic device like a computer or other digital storage device. It rapidly replaces the traditional film camera and becomes the mainstream of the camera market.

Filter is an important accessory for photographing. The filter is usually mounted on the front end of the lens barrel of the image capturing module for filtering out light beam with specific wavelength. Filters often used include UV filter, IR filter, attenuator, and polarizer.

However, such filters are often mounted on the lens barrel by screwing connection, which takes a lot of time to put on and take off and needs carefully handling to avoid damaging the lens barrel or the filter. In the other words, it is indeed not a convenient way of connection.

### SUMMARY OF THE INVENTION

The objective of the present invention is to provide a filter module, which adopted magnetic connection between the filter module and the lens barrel of the image capturing module, and capable of improving the convenience of the connection.

For achieving the above mentioned objective, the present invention provides a filter module for connecting to a lens barrel of an image capturing module. The filter module includes a filter, a frame and at least one magnetic unit. The filter is for passing through a light beam with a specific wavelength. The frame is arranged around the filter. The magnetic unit is arranged on the frame for connecting the frame to the lens barrel.

In additional aspect, the present invention provides a photographing apparatus. The photographing apparatus including an image capturing module including a lens barrel and at least a first magnetic unit arranged on the lens barrel and the above mentioned filter module. The filter module includes a filter, a frame and at least one second magnetic unit. The filter is for passing through a light beam with a specific wavelength. The frame is arranged around the filter. The second magnetic unit is arranged on the frame for connecting the frame to the lens barrel.

### BRIEF DESCRIPTION OF THE DRAWINGS

FIG. 1 is an exploded view of the photographing apparatus according to an embodiment of the present invention;

FIG. 2 is a cross sectional view of the photographing apparatus in FIG. 1; and

FIG. 3 is an exploded view of the photographing apparatus according to another embodiment of the present invention.

### DETAILED DESCRIPTION OF THE INVENTION

A detailed description of the present invention will be made with reference to the accompanying drawings.

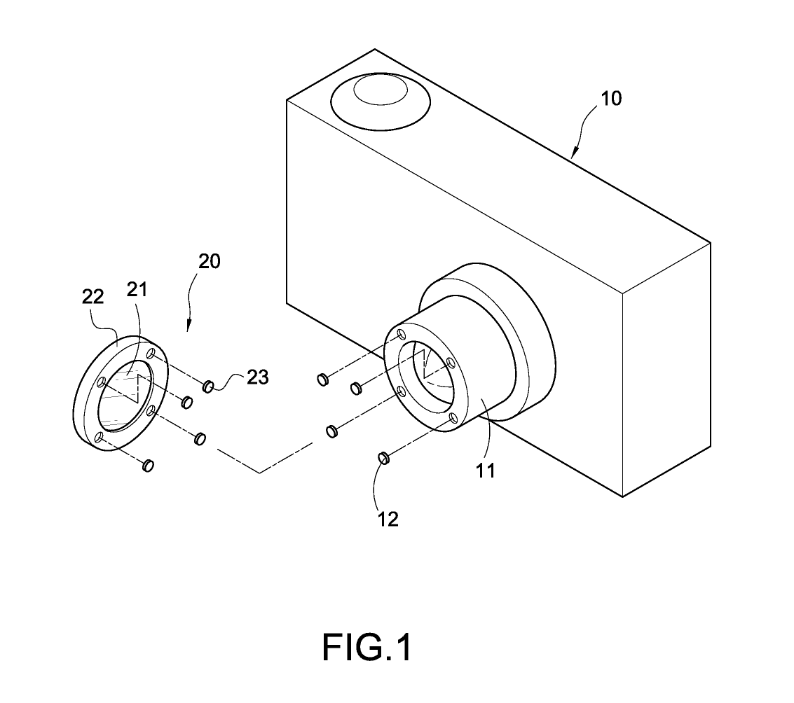

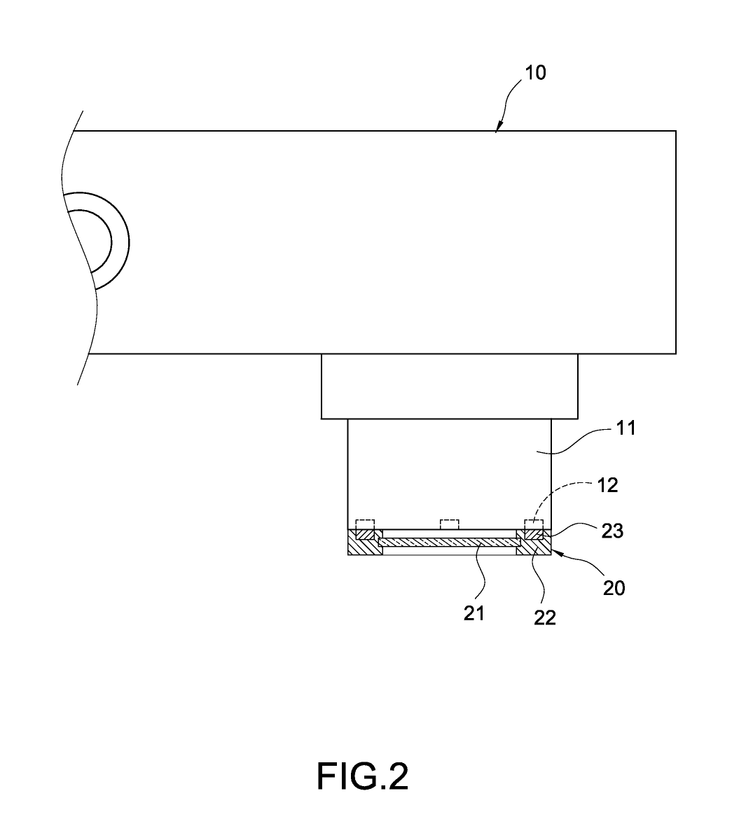

FIG. 1 and FIG. 2 show a photographing apparatus according to an embodiment of the present invention. The photographing apparatus mainly includes an image capturing module 10 and a filter module 20.

The image capturing module 10 includes a lens 11, and at least one first magnetic unit 12. In this embodiment, the number of the first magnetic unit 12 is four, which is for illustration purpose only. The image capturing module 10 can be digital camera, microscope or digital microscope.

The filter module 20 includes a filter 21, a frame 22, and at least one second magnetic unit 23. The filter 21 is for passing through a light beam with a specific wavelength. The frame 22 is arranged around the filter 21. The second magnetic units 23 are arranged on the frame 22 for magnetic connecting to the first magnetic units 12 on the lens barrel 11. The number of the second magnetic units 23 is set as equal to the number of the first magnetic units 12. Since the second magnetic units 23 can be magnetically connected to the first magnetic units 12, the filter module 20 can be quickly and easily connected to the lens barrel 11. No additional time is needed to accurately position the filter module 20 to the right place and carefully rotate it with respect to the lens barrel 11. It prevents the lens barrel 11 and the filter module 20 from damaging each other while putting on or taking off the filter module 20.

More specifically, the first magnetic units 12 have different polarizations from the corresponding second magnetic units 23. In addition, any adjacent two of the first magnetic units 12 or the second magnetic units 23 have different polarizations. Since the magnetic units have same polarizations repel from each other, and the magnetic units have different polarizations attract each other, when the filter module 20 is near the lens barrel 11, the filter module 20 will be automatically and precisely connected to the lens 11. No additional time should be wasted on the alignment between the filter module 20 and the lens barrel 11.

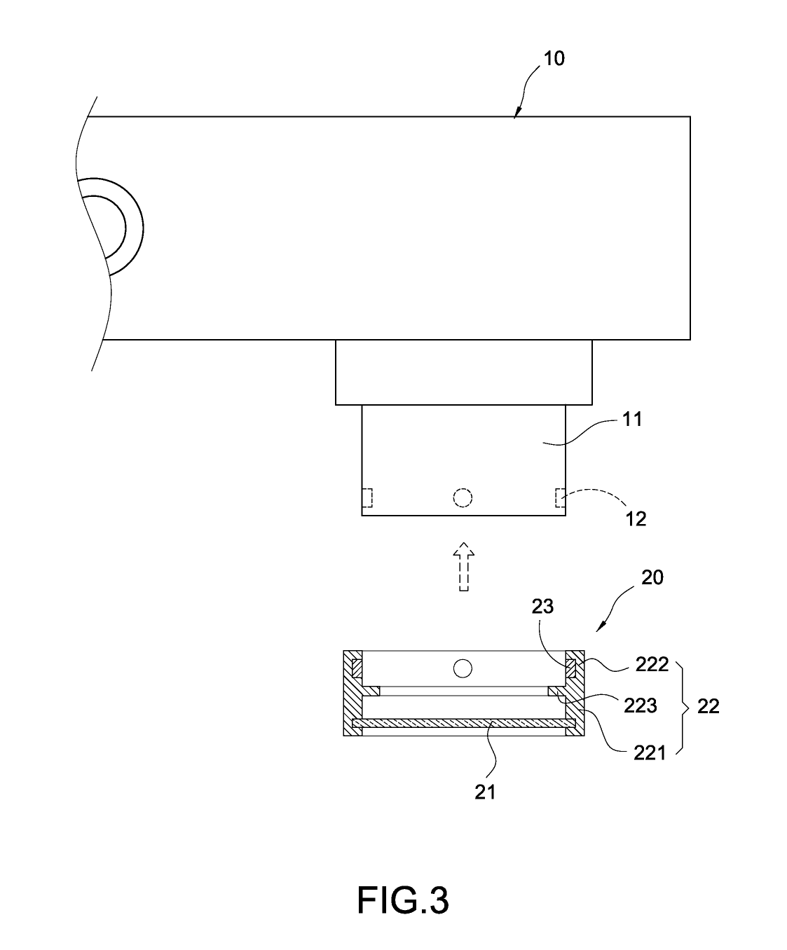

FIG. 3 shows another embodiment of the present invention. The frame 22 has a holding portion 221 for holding the filter 21, and a barrel shaped extending potion 222 extending from the holding portion 221 and toward the lens barrel 11. The inner diameter of the extending portion 222 is larger than or substantially equal to the outer diameter of the lens barrel 11, such that the lens barrel 11 is tightly sheathed by the extending portion 222. The frame 22 further includes a ring shaped stop portion 223 formed on the inner peripheral surface of the extending portion 222 for against an end surface 111 of the lens barrel 11.

The first magnetic units 12 are arranged on the outer peripheral surface of the lens barrel 11. The second magnetic units 23 are arranged on the inner peripheral surface of the extending portion 222. Since the inner diameter of the extending portion 222 is larger than or substantially equal to the outer diameter of the lens barrel 11, and the stop portion 223 is provided for against the end surface 111 of the lens barrel 11. The connection between the filter module 20 and the lens barrel 11 is more reliable and is not easy to break when impacted by an external force.

In this embodiment, the first magnetic units 12 are arranged on the outer peripheral surface of the lens barrel 11, and the second magnetic units 23 are arranged on the inner peripheral surface of the extending portion 222. In practical use, the first magnetic units 12 are arranged on the end surface 111 of the lens barrel 11 facing the filter module 20, and the second magnetic units 23 are arranged on the end surface of the extending portion 222 facing the lens barrel 11.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A filter module for connecting to a lens barrel of an image capturing module, comprising:
a filter for passing through a light beam with a specific wavelength;
a frame arranged around the filter; and
at least one magnetic unit arranged on the frame for connecting the frame to the lens barrel.

2. The filter module as claim 1, wherein the frame comprising a holding portion for holding the filter, and a barrel shaped extending portion extending from the holding portion and toward the lens barrel.

3. The filter module as claim 2, wherein the inner diameter of the extending portion is substantially equal to the outer diameter of the lens barrel such that the lens barrel is sheathed by the extending portion and the frame further comprises a ring shaped portion formed on the inner peripheral surface of the extending portion for against a end surface of the lens barrel.

4. The filter module as claim 3, wherein the magnetic unit is arranged on the inner peripheral surface of the extending portion.

5. The filter module as claim 1, comprising a plurality of the magnetic unit arranged on the frame, wherein any two adjacent magnetic units have different polarizations.

6. A photographing apparatus, comprising:
an image capturing module comprising a lens barrel and at least a first magnetic unit arranged on the lens barrel; and
a filter module comprising a filter, a frame and at least one second magnetic unit, the filter being for passing through a light beam with a specific wavelength, the frame being arranged around the filter, the second magnetic unit being arranged on the frame for connecting the frame to the lens barrel.

7. The photographing apparatus module as claim 6, wherein the frame comprising a holding portion for holding the filter, and a barrel shaped extending portion extending from the holding portion and toward the lens barrel.

8. The photographing apparatus as claim 7, wherein the inner diameter of the extending portion is substantially equal to the outer diameter of the lens barrel such that the lens barrel is sheathed by the extending portion and the frame further comprises a ring shaped portion formed on the inner peripheral surface of the extending portion for against a end surface of the lens barrel.

9. The photographing apparatus as claim 8, wherein the magnetic unit is arranged on the inner peripheral surface of the extending portion.

10. The photographing apparatus as claim 6, wherein the filter module comprises a plurality of the magnetic unit arranged on the frame, wherein any two adjacent magnetic units have different polarizations.
